(19) United States
(12) Patent Application Publication
(10) Pub. No.: US 2014/0257816 A1
(43) Pub. Date: Sep. 11, 2014

(54) SPEECH SYNTHESIS DICTIONARY MODIFICATION DEVICE, SPEECH SYNTHESIS DICTIONARY MODIFICATION METHOD, AND COMPUTER PROGRAM PRODUCT

(71) Applicant: KABUSHIKI KAISHA TOSHIBA, Tokyo (JP)

(72) Inventors: Ryo Morinaka, Suginami-ku (JP); Masatsune Tamura, Kawasaki-shi (JP); Masahiro Morita, Yokohama-shi (JP)

(73) Assignee: KABUSHIKI KAISHA TOSHIBA, Tokyo (JP)

(21) Appl. No.: 14/169,238

(22) Filed: Jan. 31, 2014

(30) Foreign Application Priority Data
Mar. 7, 2013 (JP) 2013-045757

(51) Int. Cl. G10L 13/08

(52) U.S. Cl. CPC G10L 13/08
USPC 704/260

(57) ABSTRACT

According to an embodiment, a speech synthesis dictionary modification device includes an extracting unit, a display unit, an acquiring unit, an modification unit, and an updating unit. The extracting unit extracts a synthesis information containing a feature sequence of a synthetic speech from the synthetic speech generated by using a speech synthesis dictionary containing probability distributions of speech features. The display unit displays an image prompting to modify a probability distribution contained in the speech synthesis dictionary on a basis of the synthesis information extracted by the extracting unit. The acquiring unit acquires an instruction to modify the probability distribution contained in the speech synthesis dictionary. The modification unit modifies the probability distribution contained in the speech synthesis dictionary according to the instruction. The updating unit updates the speech synthesis dictionary on a basis of a result of modifying by the modification unit to generate a new speech synthesis dictionary.

### CROSS-REFERENCE TO RELATED APPLICATION(S)

This application is based upon and claims the benefit of priority from Japanese Patent Application No. 2013-045757, filed on Mar. 7, 2013; the entire contents of which are incorporated herein by reference.

### FIELD

An embodiment described herein relates generally to a speech synthesis dictionary modification device, a speech synthesis dictionary modification method, and a computer program product.

### BACKGROUND

Speech synthesis technologies based on the hidden Markov model (hereinafter referred to as HMM) are widely known as text speech synthesis for artificially generating a speech signal from a certain text. With such a technology, the quality of speech synthesis dictionary has a significant effect on the quality of synthetic speech. Furthermore, it is known to perform HMM training multiple times in order to improve the quality of speech synthesis dictionary.

In the related art, however, multiple times of HMM training may cause a problem in the quality of synthetic speech that originally has no problem in the quality, which is disadvantageous in that the quality of the synthetic speech dictionary cannot be efficiently improved.

### BRIEF DESCRIPTION OF THE DRAWINGS

FIG. 1 is a configuration diagram illustrating an example of a configuration of a speech synthesis dictionary modification device and peripherals thereof according to an embodiment;

FIG. 2 is a diagram illustrating an example of a decision tree and probability distributions contained in a first speech synthesis dictionary;

FIG. 3 is a flowchart illustrating exemplary operation of the speech synthesis dictionary modification device;

FIG. 4 is a flowchart illustrating association between procedures performed on the speech synthesis dictionary modification device by the user and the operation of the speech synthesis dictionary modification device;

FIG. 5 is a diagram illustrating a first example of an image displayed by a display unit;

FIG. 6 is a diagram illustrating a second example of an image displayed by the display unit;

FIG. 7 is a table illustrating a list of distributions to be selected for each HMM state of each speech feature for a context feature with the same current phoneme;

FIG. 8 is a diagram illustrating an example of a replacement support image displayed by the display unit;

FIG. 9 is a diagram illustrating an example of a split support image displayed by the display unit;

FIG. 10 is a conceptual diagram illustrating an example of a decision tree obtained by splitting a leaf node; and

FIG. 11 is a conceptual diagram illustrating an example of a decision tree obtained by merging leaf nodes.

### DETAILED DESCRIPTION

According to an embodiment, a speech synthesis dictionary modification device includes an extracting unit, a display unit, an acquiring unit, a modification unit, and an updating unit. The extracting unit is configured to extract a synthesis information containing a feature sequence of a synthetic speech from the synthetic speech generated by using a speech synthesis dictionary containing probability distributions of speech features. The display unit is configured to display an image prompting to modify a probability distribution contained in the speech synthesis dictionary on a basis of the synthesis information extracted by the extracting unit. The acquiring unit is configured to acquire an instruction to modify the probability distribution contained in the speech synthesis dictionary. The modification unit is configured to modify the probability distribution contained in the speech synthesis dictionary according to the instruction. The updating unit is configured to update the speech synthesis dictionary on a basis of a result of modification by the modification unit to generate a new speech synthesis dictionary.

For describing a speech synthesis dictionary modification device according to an embodiment, HMM speech synthesis using a speech synthesis dictionary modified by the speech synthesis dictionary modification device will be first described.

In the HMM speech synthesis, a speech synthesis dictionary obtained by performing training based on the HMM (hereinafter referred to as HMM training) is required. In typical HMM training, a speech database containing a plurality of speech feature such as spectra and pitches extracted from speech data, context feature labels associated with speech data, and the like is used.

A speech synthesis dictionary obtained through HMM training contains a decision tree and a probability distribution for each HMM state and each speech feature.

Furthermore, a typical HMM speech synthesizer includes a language processing unit, a state duration generating unit, a feature sequence generating unit, and a waveform generating unit, and generates synthetic speech.

First, the language processing unit performs morphological analysis, syntactic analysis, and the like on an input text to generate a context feature label for each phoneme.

Subsequently, the state duration generating unit selects a probability distribution for each phoneme by using a decision trees and context feature labels associated with state durations contained in the speech synthesis dictionary, and generates a duration for each HMM state of each phoneme by using the selected probability distribution.

Subsequently, the feature sequence generating unit selects a probability distribution for each HMM state by using a decision tree and a context feature label for each HMM state of each speech feature contained in the speech synthesis dictionary. The feature sequence generating unit further generates a feature sequence for each speech feature from the selected probability distribution and the state duration.

Finally, the waveform generating unit generates an excitation source from a pitch feature sequence or the like, and generates synthetic speech by using a synthesis filter corresponding to a spectral feature sequence.

Speech synthesis dictionary modification device

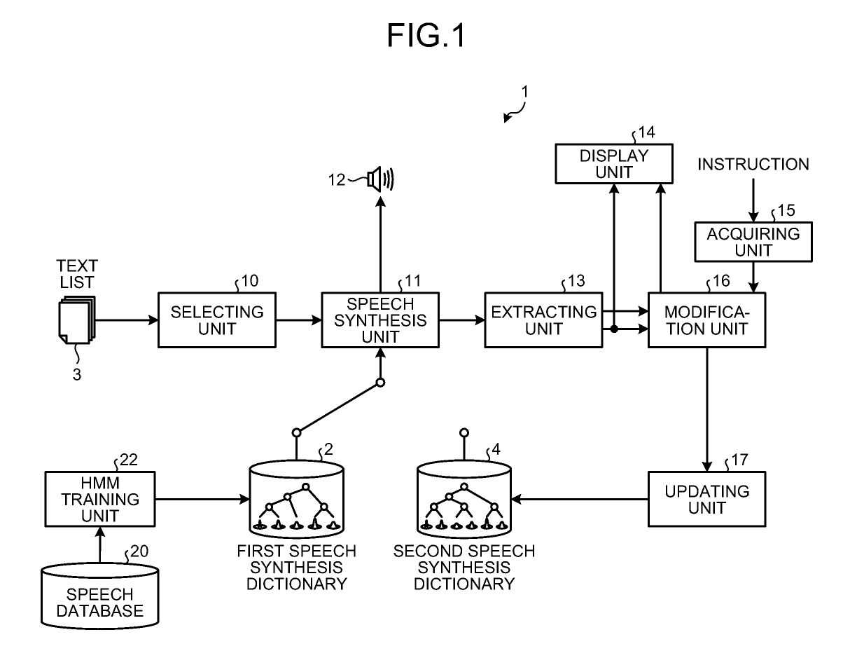

FIG. 1 is a configuration diagram illustrating an example of a configuration of a speech synthesis dictionary modification device 1 and peripherals according to the embodiment. Note that the speech synthesis dictionary modification device 1 is implemented by a general-purpose computer, for example. That is, the speech synthesis dictionary modification device 1 has functions as a computer including a CPU, a storage device, an input/output device, a communication interface, and the like.

As illustrated in FIG. 1, the speech synthesis dictionary modification device 1 includes a selecting unit 10, a speech synthesis unit 11, a speaker 12, an extracting unit 13, a display unit 14, an acquiring unit 15, a modification unit 16, and an updating unit 17, for example. The speech synthesis dictionary modification device 1 receives a first speech synthesis dictionary 2 to be modified (before modification), A text list 3 indicating texts, and an instruction from the user, and outputs a second speech synthesis dictionary 4 resulting from modification. Note that the selecting unit 10, the speech synthesis unit 11, the extracting unit 13, the acquiring unit 15, the modification unit 16, and the updating unit 17 may be either hardware circuits or software (programs) executed by the CPU.

The first speech synthesis dictionary 2 is generated by an HMM training unit 22 by performing HMM training using a speech database 20. The speech database 20 is a database containing a plurality of speech features such as spectra and pitches extracted from speech data, context feature labels associated with speech data, and the like. A context feature label contains, for each phoneme, information such as the current, the previous and the following phonemes, a mora position of the current phoneme within a stressed phrase, and mora lengths of the current, the previous and the following stressed phrases.

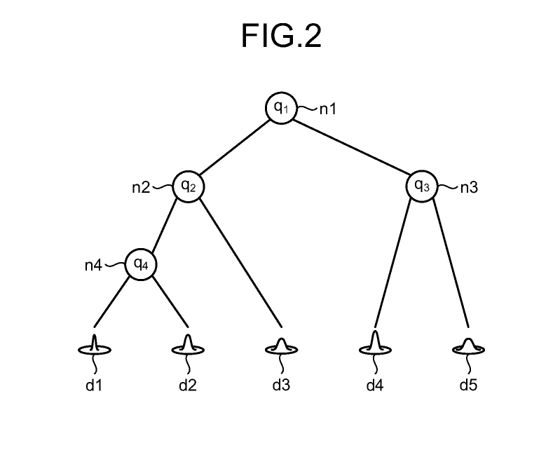

The first speech synthesis dictionary 2 contains decision trees and probability distributions for each HMM state and for each speech feature. A decision tree allows selection of a probability distribution according to a context. FIG. 2 is a diagram illustrating an example of a decision tree and probability distributions contained in the first speech synthesis dictionary 2. The decision tree is used to select a probability distribution according to the context. A question (q1 to q4) relating to a context feature is assigned to each of nodes (n1 to n4) of the decision tree. In addition, a probability distribution (d1 to d5) is associated with each of leaf nodes. Each of the probability distributions (d1 to d5) contains at least a mean (expressed in a form of a scalar value or a vector) and a variance (expressed in a form of a scalar value or a matrix).

The text list 3 is a list obtained by extracting a plurality of texts with problems in the quality of synthetic speech when synthetic speech is generated from texts provided in advance by using the first speech synthesis dictionary 2, for example. Synthetic speech having a problem in the quality refers to synthetic speech containing defects in audibility such as a high (or low) pitch or a short (or long) duration including abnormal noise, for example. The text list 3 may be input to the selecting unit 10 from a storage device or a communication interface, which is not illustrated, of the speech synthesis dictionary modification device 1.

The selecting unit 10 selects a text from which the speech synthesis unit 11 synthesizes speech from the text list 3, and outputs the selected text to the speech synthesis unit 11. If there is no text list 3, the selecting unit 10 may output any text as the selected text.

The speech synthesis unit 11 generates synthetic speech by using the text selected by the selecting unit 10 and the first speech synthesis dictionary 2 (or the second speech synthesis dictionary 4, which will be described later). The speech synthesis unit 11 then outputs synthetic speech to the speaker 12 and outputs information (synthesis information) necessary for generating synthetic speech to the extracting unit 13. The synthesis information is information containing, for each speech feature, a result of selecting a probability distribution in each HMM state of each phoneme and information in speech synthesis such as a generated feature sequence.

That is, the speech synthesis unit 11 allows the user to compare the synthetic speech generated by using the first speech synthesis dictionary 2 to be modified with synthetic speech generated by using the second speech synthesis dictionary 4 resulting from modification. The user can check whether or not the problem in the quality has been solved by comparing the two synthetic speeches.

The extracting unit 13 analyzes the synthesis information received from the speech synthesis unit 11, and extracts the result of selecting a probability distribution in each HMM state of each phoneme and the generated feature sequence as synthesis information effective for modifying for each speech feature. The extracting unit 13 then outputs the generated feature sequence to the display unit 14 and outputs the result of selecting a probability distribution and the generated feature sequence to the modification unit 16.

The display unit 14 is a display device, for example, that displays an image to prompt modifying of probability distributions contained in the first speech synthesis dictionary 2 (or the second speech synthesis dictionary 4, which will be described later) on the basis of synthesis information such as the feature sequence generated by using the first speech synthesis dictionary 2 (or the second speech synthesis dictionary 4, which will be described later). The display unit 14 can also display an image based on a result of modifying by the modification unit 16, which will be described later. Accordingly, the user can refer to the image displayed by the display unit 14 to determine the modification policy.

The acquiring unit 15 acquires an instruction (instruction information) to perform modification from the user that has referred to the image displayed by the display unit 14 and is prompted to perform modification, for example, via an input/output device or the like that is not illustrated, and outputs the acquired instruction to the modification unit 16. For example, the acquiring unit 15 acquires specifying information specifying a probability distribution as the instruction.

The modification unit 16 receives the result of selecting a probability distribution and the generated feature sequence from the extracting unit 13 and receives the instruction from the acquiring unit 15. The modification unit 16 then modifies the probability distribution selected for the phoneme and the HMM state causing the problem in the quality of synthetic speech, the probability distribution selected for the phoneme and the HMM state within a range that the user desires to modify, and the leaf nodes of the decision trees associated with the respective probability distributions according to the instruction received from the acquiring unit 15. For example, the modification unit 16 modifies the probability distribution so that the error between the feature sequence of synthetic speech contained in the synthesis information extracted by the extracting unit 13 and the feature sequence of synthetic speech contained in the synthesis information specified by the instruction will be minimized. The modification unit 16 also displays an image based on the result of modifying the probability distribution on the display unit 14, and outputs the result of modifying the probability distribution to the updating unit 17 according to the instruction received by the acquiring unit 15.

For example, the modification unit 16 modifies a probability distribution by modifying the mean and variance values of the probability distribution or replacing the probability distribution with another probability distribution according to the instruction received by the acquiring unit 15. The modification unit 16 also modifies leaf nodes of a decision tree by setting a question on a leaf node to split the leaf node or merging a plurality of leaf nodes included in a subtree in which an ancestor node of the leaf node is a root node according to the instruction received from the acquiring unit 15.

Depending on the speech feature, however, it is difficult for the user to input an instruction to directly modify mean and variance values of a probability distribution to the speech synthesis dictionary modification device 1. The user thus refers to the image displayed by the display unit 14, determines the modification policy according to the property of the speech feature, and input an instruction for modification according to the modification policy to the speech synthesis dictionary modification device 1.

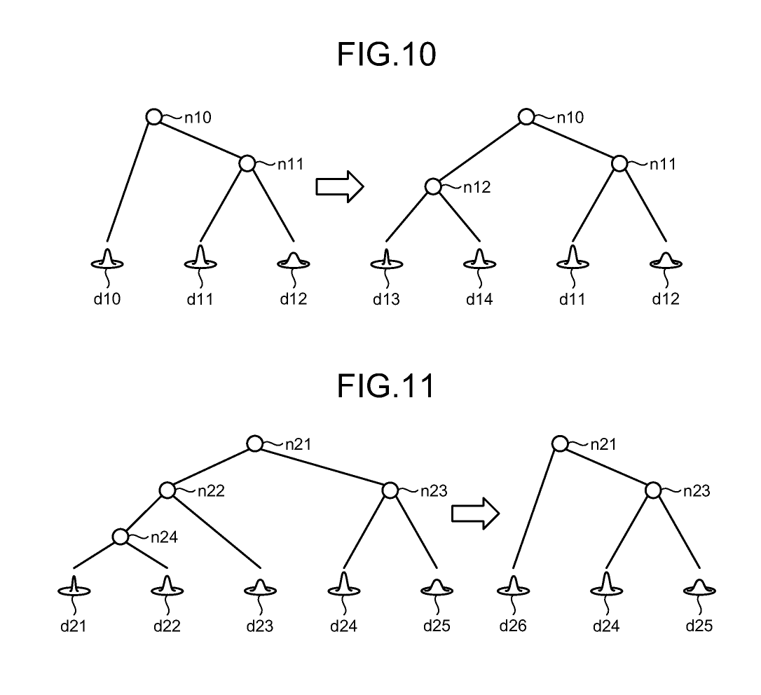

The updating unit 17 updates the first speech synthesis dictionary 2 on the basis of the result of modification the probability distribution by the modification unit 16 to newly generate the second speech synthesis dictionary 4, for example, and outputs the generated second speech synthesis dictionary 4. The result of modifying by the modification unit 16 will be described later with reference to FIGS. 10 and 11 as an example.

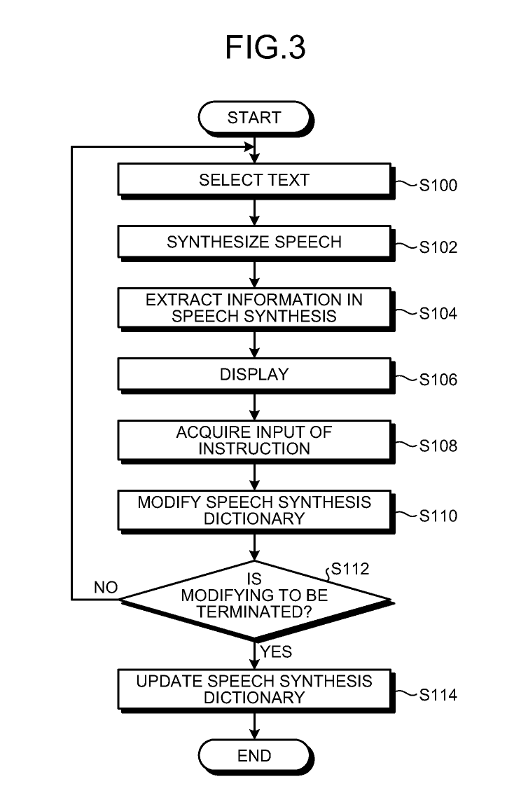

Next, the operation of the speech synthesis dictionary modification device 1 will be described. FIG. 3 is a flowchart illustrating exemplary operation of the speech synthesis dictionary modification device 1 (speech synthesis dictionary modification programs). In step 100 (S100), the selecting unit 10 selects a text from which speech is to be synthesized from the text list 3, for example.

In step 102 (S102), the speech synthesis unit 11 synthesizes speech (generates synthetic speech) for the text selected in the processing of S100, and outputs synthesis information to the extracting unit 13.

In step 104 (S104), the extracting unit 13 extracts information in speech synthesis. Specifically, the extracting unit 13 extracts the result of selecting a probability distribution and a generated feature sequence from the synthesis information as synthesis information effective for modification.

In step 106 (S106), the display unit 14 displays an image prompting the user to modify the probability distribution on the basis of the result of extraction in the processing of S104.

In step 108 (S108), the acquiring unit 15 acquires an instruction (input of an instruction) to modify the probability distribution from the user who referred to the image displayed by the display unit 14.

In step 110 (S110), the modification unit 16 modifies the first speech synthesis dictionary 2 according to the instruction acquired in the processing of S108.

In step 112 (S112), the speech synthesis dictionary modification device 1 (the CPU that is not illustrated, for example) determines whether or not to terminate modification of the first speech synthesis dictionary 2 in response to input of an instruction from the user acquired via the acquiring unit 15, for example. If modification of the first speech synthesis dictionary 2 is to be terminated (S112: Yes), the speech synthesis dictionary modification device 1 proceeds to processing of S114. If, on the other hand, modification of the first speech synthesis dictionary is not to be terminated (S112: No), the speech synthesis dictionary modification device 1 proceeds to the processing of S100.

In step 114 (S114), the updating unit 17 updates the first speech synthesis dictionary 2 on the basis of the result of modification by the modification unit 16 to newly generate the second speech synthesis dictionary 4, and outputs the generated second speech synthesis dictionary 4.

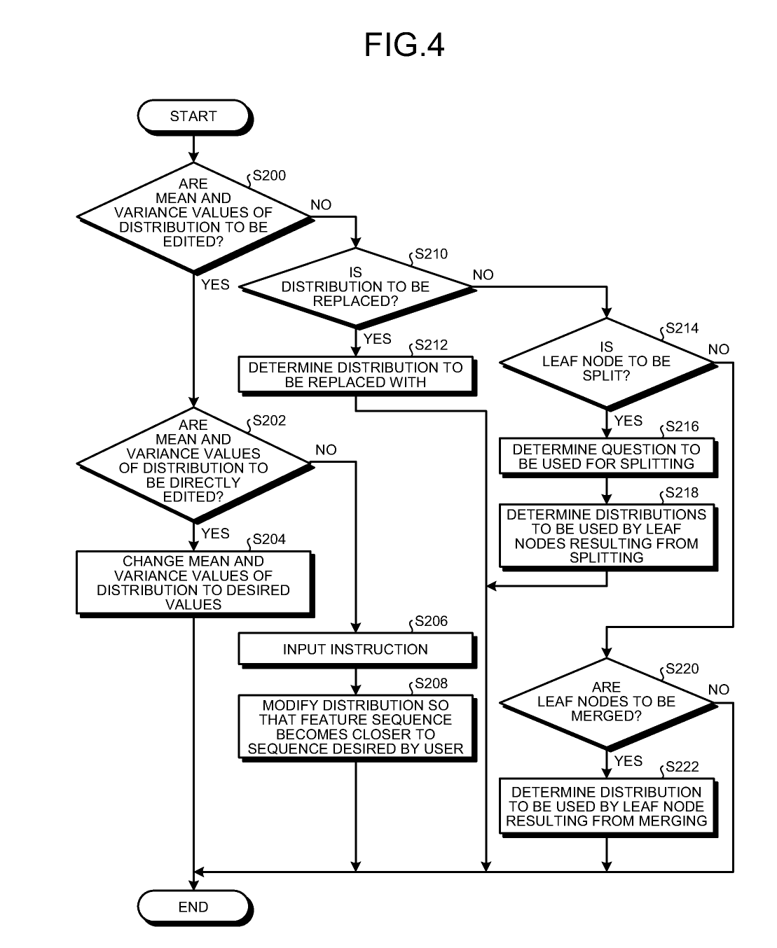

Next, procedures performed on the speech synthesis dictionary modification device 1 by the user and the operation of the speech synthesis dictionary modification device 1 will be described. FIG. 4 is a flowchart illustrating association between the procedures performed on the speech synthesis dictionary modification device 1 by the user and the operation of the speech synthesis dictionary modification device 1. As illustrated in FIG. 4, in step 200 (S200), the user determines whether or not to modify mean and variance values of a probability distribution (hereinafter referred to as distribution). If mean and variance values of the distribution are to be modified (S200: Yes), the user proceeds to processing of S202. If, on the other hand, no mean and variance values of the distribution are to be modified (S200: No), the user proceeds to processing of S210.

In step 202 (S202), the user determines whether or not to directly modify the mean and variance values of the distribution. If the mean and variance values of the distribution are to be directly modified (S202: Yes), the user proceeds to processing of S204. If, on the other hand, the mean and variance values of the distribution are not to be directly modified (S202: No), the user proceeds to processing of S206.

In step 204 (S204), the user changes some or all of the mean and variance values of the distribution to desired values. For example, when the duration of a phoneme or the duration of a state generated by using a distribution is too long (or too short), the user modifies the distribution regarding the state duration by changing the mean value of the distribution to a desired duration. Similarly, the user performs modification so that the variance values of the distribution are changed to desired values. In this process, the user refers to an image displayed by the display unit 14, for example, and changes the mean and variance values of the distribution to desired values.

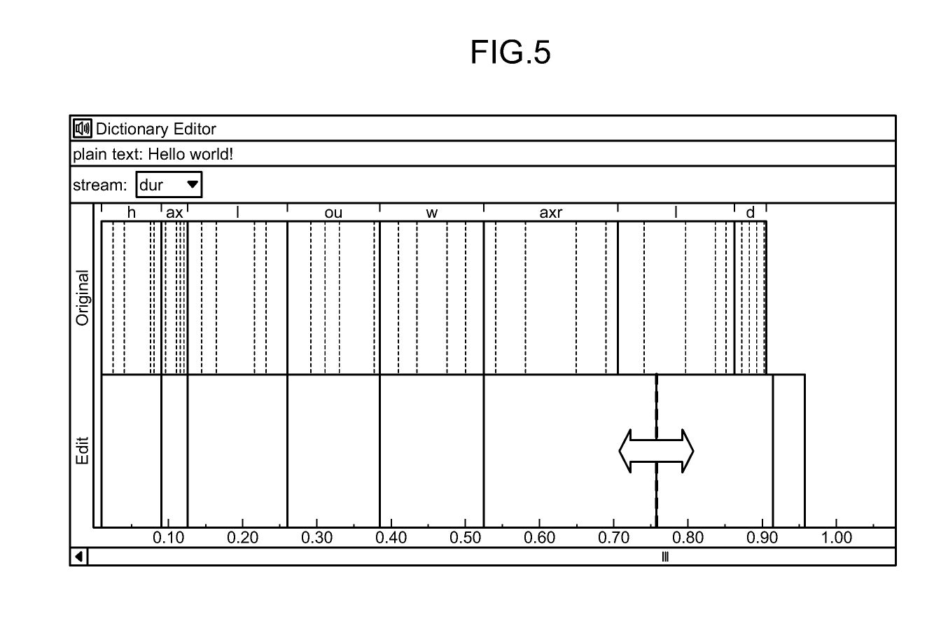

FIG. 5 is a diagram (exemplary image) illustrating a first example of the image displayed by the display unit 14 in the processing of S204. In FIG. 5, the upper part (Original) illustrates the duration for each state of each phoneme before modification. The vertical dotted lines represent boundaries between states, and vertical solid lines represent boundaries between phonemes. The lower part (Modify) illustrates an example in which the user performs a modifying operation on the duration of a phoneme “axr” by using an input/output device (a mouse, for example). When the user performs such a modifying operation, the modification unit 16 modifies the values by multiplying the mean value of the distribution used in generating the duration of “axr” by a ratio of the duration of the phoneme “axr” before modification and the duration of the phoneme after modification.

In step 206 (S206), the user inputs an instruction to modify the distribution (by using a feature sequence, for example) to the speech synthesis dictionary modification device 1.

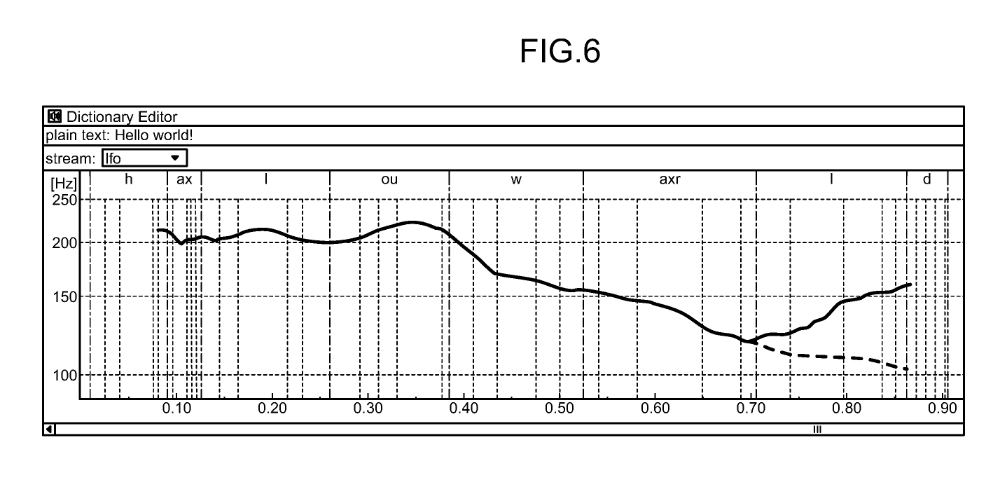

FIG. 6 is a diagram (exemplary image) illustrating a second example of the image displayed by the display unit 14 in the processing of S206. In FIG. 6, the thick broken line represents a feature sequence before modification, and the thick solid line represents a desired feature sequence (that is, an instruction) resulting from modification by the user using an input/output device (a mouse, for example).

In step 208 (S208), the modification unit 16 modifies the distribution so that part or the whole of a sequence of dimensions corresponding to powers of spectral features and pitch feature sequence to be closer to the feature sequence desired by the user. For example, the modification unit 16 modifies the distribution by using a known technology such as the MGE (minimum generation error) training so that errors between the feature sequence generated by using the modified distribution and the feature sequence desired by the user (specified by the instruction) will be minimized. Thus, the user can modify the distribution without directly controlling the mean and variance values of the distribution.

In step 210 (S210), the user determines whether or not to replace the distribution. For example, if there is abnormal noise in the synthetic speech (the synthesized phoneme is not sounded as intended), the user determines that the distribution is to be replaced. If the distribution is to be replaced (S210: Yes), the user proceeds to processing of S212. If, on the other hand, the distribution is not to be replaced (S210: No), the user proceeds to processing of S214.

In step 212 (S212), the user determines the distribution to be replaced with (replace the probability distribution with another probability distribution). If the distribution is to be replaced, the user selects a distribution to be replaced with from distributions listed in advance that are selected according to context features in which the current phoneme is the same, according to context features in which a triphone of a combination of the previous phoneme, the current phoneme and the following phoneme is the same or similar, and the like.

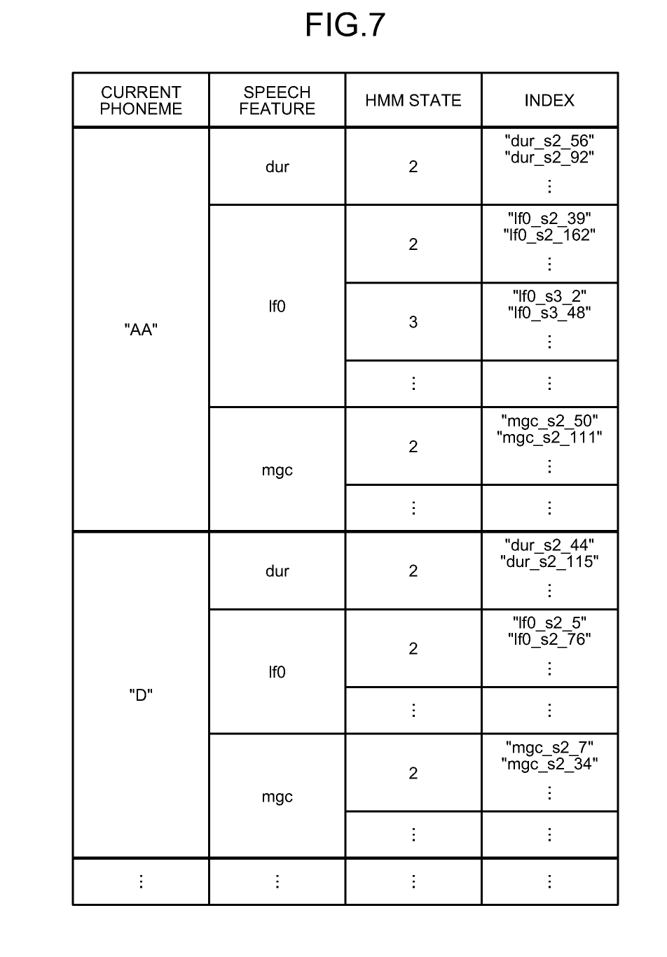

FIG. 7 is a table illustrating a list of distributions to be selected depending on the HMM state of each speech feature for a context feature with the same current phoneme. Distributions are represented by indices.

When the user inputs to the speech synthesis dictionary modification device 1 that the distribution is determined to be replaced, for example, the display unit 14 displays a replacement support image supporting replacement of the probability distribution. The replacement support image contains a list of distributions in which the current phoneme is the same, the speech feature is the same, or the HMM state is the same, for example.

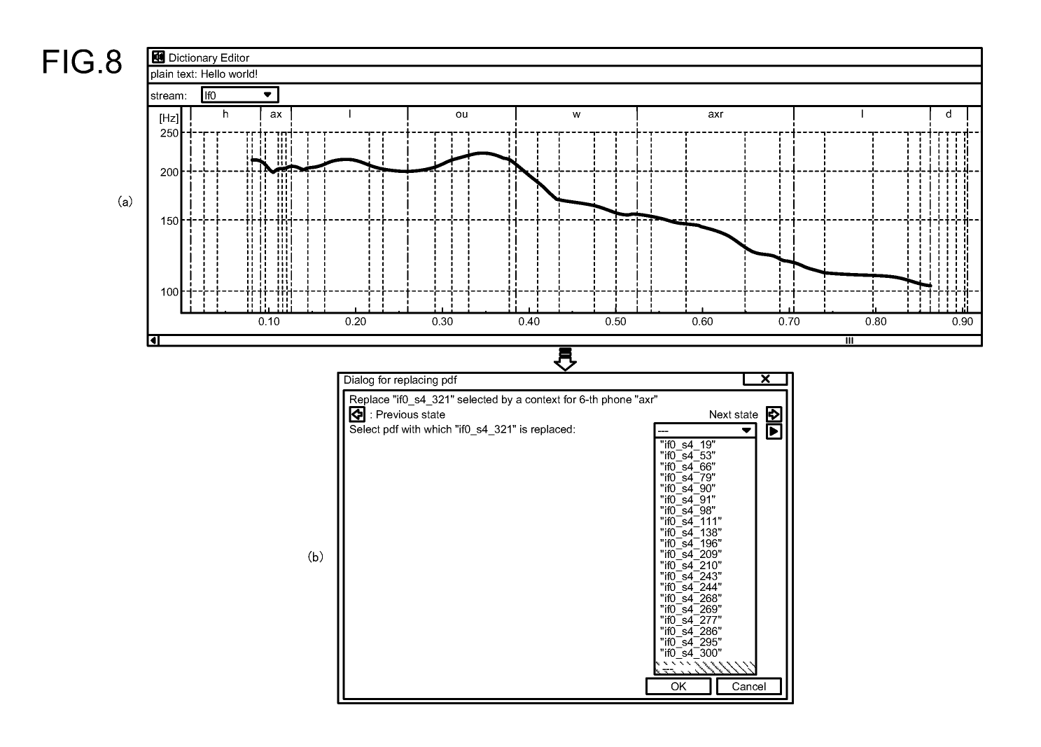

FIG. 8 is a diagram (exemplary image) illustrating an example of the replacement support image displayed by the display unit 14 in the processing of S212. Section (b) of FIG. 8 is an image presenting a list of distributions that can be replaced with for a phoneme selected from a feature sequence illustrated in section (a) of FIG. 8. In section (b) of FIG. 8, indices of corresponding distributions are extracted from the list of FIG. 7.

Thus, the modification unit 16 replaces the original distribution to be replaced with a distribution (whose index is) selected by the user from the list presented in section (b) of FIG. 8. In this manner, the user can modify the distribution by selecting a distribution from a list without directly operating mean and variance values.

In step 214 (S214), the user determines whether or not to split a leaf node of a decision tree. If the leaf node of the decision tree is to be split (S214: Yes), the user proceeds to processing of S216). If the leaf node of the decision tree is not to be split (S214: No), the user proceeds to processing of S220.

In step 216 (S216), the user determines a question to be used for splitting. When the user inputs to the speech synthesis dictionary modification device 1 that the leaf node of the decision tree is to be split, for example, the display unit 14 displays a split support image supporting splitting of a distribution.

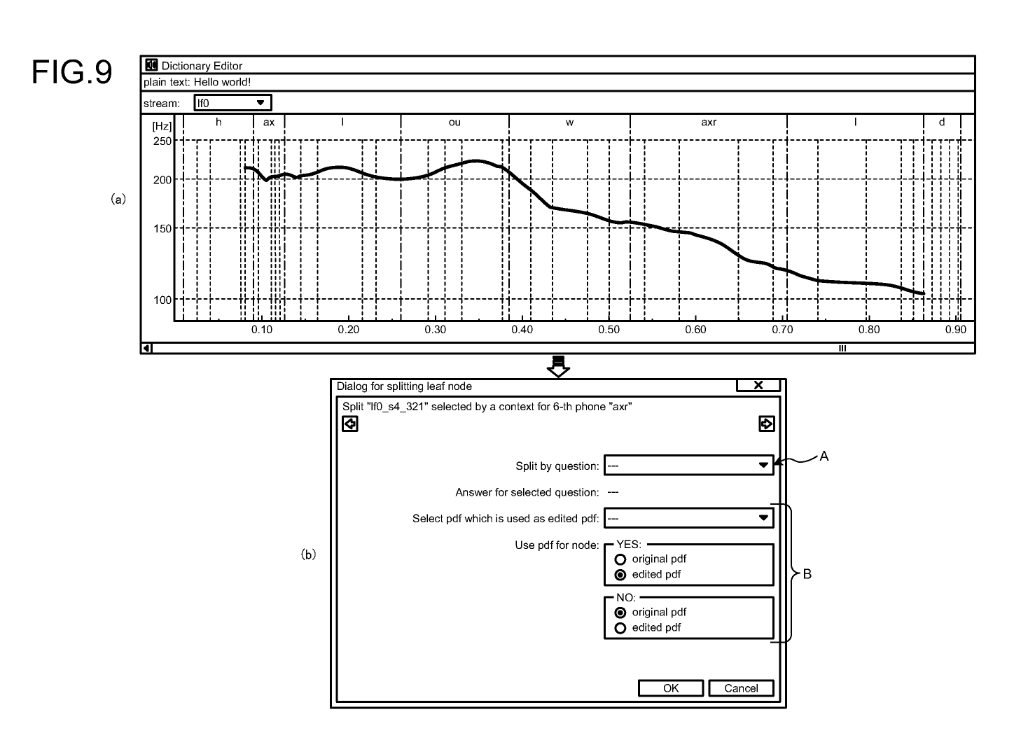

FIG. 9 is a diagram (exemplary image) illustrating an example of the split support image displayed by the display unit 14. Section (b) of FIG. 9 is an image supporting splitting for a phoneme selected from a feature sequence illustrated in section (a) of FIG. 9. The split support image contains a question determination part A for selecting a question to be used for splitting the leaf node of the decision tree from a list to determine the question, and a distribution determination part B for determining distributions to be associated with two leaf nodes generated as a result of splitting. Note that the question to be used for splitting a leaf node can be arbitrarily set by the user.

The question determination part A displays the list of questions to be used for splitting the leaf node so that the user selects a question to determine the question to be used for splitting.

In step 218 (S218), the user determines distributions to be used by the leaf nodes resulting from the splitting. The distribution determination part B illustrated in section (b) of FIG. 9 supports the user to determine distributions to be associated with the two leaf nodes by displaying a list and with radio buttons.

Specifically, in the processing of S216 and S218, the user can associate distributions that are different only in a specific context feature among multiple context features for selecting a leaf node associated with a distribution. Note that section (b) of FIG. 9 illustrates an example in which a context where the answer to the question selected from the list displayed in the question determination part A is “yes” is associated with a distribution selected from the list in the distribution determination part B and a context where the answer is “no” is associated with the distribution before splitting.

FIG. 10 is a conceptual diagram illustrating an example of a decision tree obtained by splitting a leaf node. FIG. 10 illustrates a case in which a question is set for a leaf node associated with a distribution d10 and the leaf node is changed to a node n12. Furthermore, two leaf nodes (corresponding to child nodes of the node n12) generated as a result of splitting the leaf node associated with the distribution d10 are respectively associated with distributions d13 and d14. The distributions d13 and d14 can be arbitrarily set by the user and either one thereof may be the same as the distribution d10. Thus, the decision tree in which the leaf node is split and the distributions d13 and d14 are associated is an example of a result of modification by the modification unit 16.

Note that, for splitting the leaf node associated with the probability distribution d2 in the decision tree illustrated in FIG. 2, the question to be used for splitting needs to be determined taking questions q1, q2 and q4 and answers thereto into consideration. If the question is determined without taking the questions q1, q2 and a4 and the answers thereto into consideration, only one of leaf nodes generated as a result of splitting the leaf node may be selected, which does not produce the effect to be produced by splitting the leaf node.

In step 220 (S220), the user determines whether or not to integrate leaf nodes in a decision tree. If the leaf nodes in the decision tree are to be merged (S220: Yes), the user proceeds to processing of S222. If, on the other hand, the leaf nodes in the decision tree are not to be merged (S220: No), the user terminates the process.

In step 222 (S222), the user selects a node that will newly be a leaf node after merging a plurality of leaf nodes into a leaf node. Furthermore, the user determines a distribution to be associated with the new leaf node.

FIG. 11 is a conceptual diagram illustrating an example of a decision tree obtained by merging leaf nodes. In FIG. 11, a node n22 is selected from ancestor nodes of the leaf node associated with a distribution d22 as a new leaf node after merging of the leaf nodes. A distribution d26 to be associated with the new leaf node can be arbitrarily set by the user. For example, the user may obtain the mean and the variance of the distribution d26 from the mean and the variances of the probability distributions d21 to d23 associated with the leaf nodes included in a subtree in which the node n22 is a root node. Alternatively, the user may use one of the distributions d21 to d23 as the distribution d26. As described above, the decision tree in which the leaf nodes are merged and associated with the distribution d26 is an example of a result of modifying by the modification unit 16.

As described above, since the speech synthesis dictionary modification device 1 according to the embodiment generates the second speech synthesis dictionary 4 by modification only part of the first speech synthesis dictionary 2 for a text in which a problem in the quality occurred, the quality of the speech synthesis dictionary can be efficiently improved. That is, texts without any problems in the quality of synthetic speech generated by using the first speech synthetic dictionary 2 will not have any problems in the quality of synthetic speech generated by using the second speech synthetic dictionary 4. Furthermore, the speech synthesis dictionary modification device 1 allows synthetic speech without any problems in the quality to be generated from a text, even when a problem in the quality occurs in synthetic speech generated from the text by using the first speech synthesis dictionary 2, by using the second speech synthesis dictionary 4 modified by the modification unit 16 so that the problem in the quality is solved.

Speech synthesis dictionary modification programs to be executed by the speech synthesis dictionary modification device 1 according to the embodiment are recorded on a computer readable recording medium such as a CD-ROM, a flexible disk (FD), a CD-R, and a DVD (digital versatile disk) in a form of a file that can be installed or executed, and provided therefrom.

Alternatively, the speech synthesis dictionary modification programs to be executed by the speech synthesis dictionary modification device 1 according to the embodiment may be stored on a computer system connected to a network such as the Internet, and provided by being downloaded via the network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A speech synthesis dictionary modification device comprising:
an extracting unit configured to extract a synthesis information containing a feature sequence of a synthetic speech from the synthetic speech generated by using a speech synthesis dictionary containing probability distributions of speech features;
a display unit configured to display an image prompting to modify a probability distribution contained in the speech synthesis dictionary on a basis of the synthesis information extracted by the extracting unit;
an acquiring unit configured to acquire an instruction to modify the probability distribution contained in the speech synthesis dictionary;
a modification unit configured to modify the probability distribution contained in the speech synthesis dictionary according to the instruction; and
an updating unit configured to update the speech synthesis dictionary on a basis of a result of modification by the modification unit to generate a new speech synthesis dictionary.

2. The device according to claim 1, wherein the modification unit is configured to modify the probability distribution contained in the speech synthesis dictionary by replacing the probability distribution contained in the speech synthesis dictionary.

3. The device according to claim 2, wherein the modification unit is configured to replace the probability distribution by using a probability distribution used by a context similar to a context using the probability distribution to be modified.

4. The device according to claim 3, wherein
the display unit is configured to display a list of probability distributions used by a context similar to the context using the probability distribution to be modified,
the acquiring unit is configured to acquire specifying information specifying a probability distribution contained in the list, and
the modification unit is configured to replace the probability distribution to be modified with the probability distribution specified by the specifying information.

5. The device according to claim 1, wherein the modification unit is configured to modify the probability distribution contained in the speech synthesis dictionary in such a way that the synthesis information extracted by the extracting unit is closer to synthesis information specified by the instruction.

6. The device according to claim 5, wherein the modification unit is configured to modify the probability distribution contained in the speech synthesis dictionary in such a way that errors between a feature sequence of synthetic speech contained in the synthesis information extracted by the extracting unit and a feature sequence of synthetic speech contained in the synthesis information specified by the instruction is minimized.

7. The device according to claim 1, wherein
the speech synthesis dictionary contains a decision tree allowing selection of a probability distribution depending on a context, and
the modification unit is configured to modify the probability distribution contained in the speech synthesis dictionary by splitting a leaf node in the decision tree.

8. The device according to claim 1, wherein
the speech synthesis dictionary contains a decision tree allowing selection of a probability distribution depending on a context, and
the modification unit is configured to modify the probability distribution contained in the speech synthesis dictionary by merging a plurality of leaf nodes included in the decision tree.

9. The device according to claim 1, wherein the updating unit is configured to update the speech synthesis dictionary on a basis of a result of replacing, splitting or merging leaf nodes contained in a decision tree allowing selection of a probability distribution depending on a context by the modification unit to generate a new speech synthesis dictionary.

10. A speech synthesis dictionary modification method comprising:
extracting synthesis information containing a feature sequence of synthetic speech generated by using a speech synthesis dictionary containing probability distributions of speech features;
displaying an image prompting to modify a probability distribution contained in the speech synthesis dictionary on a basis of the extracted synthesis information;
acquiring an instruction to modify the probability distribution contained in the speech synthesis dictionary;
modifying the probability distribution contained in the speech synthesis dictionary according to the instruction; and
updating the speech synthesis dictionary on a basis of a result of modification to generate a new speech synthesis dictionary.

11. A computer program product comprising a computer-readable medium containing speech synthesis dictionary modification program, the program causing a computer to execute:
extracting synthesis information containing a feature sequence of synthetic speech generated by using a speech synthesis dictionary containing probability distributions of speech features;
displaying an image prompting to modify a probability distribution contained in the speech synthesis dictionary on a basis of the extracted synthesis information;
acquiring an instruction to modify the probability distribution contained in the speech synthesis dictionary;
modifying the probability distribution contained in the speech synthesis dictionary according to the instruction; and
updating the speech synthesis dictionary on a basis of a result of modification to generate a new speech synthesis dictionary.
